(19) United States
(12) Patent Application Publication
(10) Pub. No.: US 2018/0234234 A1
(43) Pub. Date: Aug. 16, 2018

(54) SYSTEM FOR DESCRIBING AND TRACKING THE CREATION AND EVOLUTION OF DIGITAL FILES

(71) Applicant: Secured FTP Hosting, LLC d/b/a SmartFile, Indianapolis, IN (US)

(72) Inventors: John Hurley, Carmel, IN (US); Ben Timby, Brownsburg, IN (US); Travis Cunningham, Indianapolis, IN (US); Anthony Spelde, Indianapolis, IN (US)

(21) Appl. No.: 15/893,441

(22) Filed: Feb. 9, 2018

Related U.S. Application Data
(60) Provisional application No. 62/457,553, filed on Feb. 10, 2017.

(51) Int. Cl. H04L 9/06; G06F 17/30; G06F 21/10; G06F 21/60; H04L 9/32

(52) U.S. Cl. CPC H04L 9/0643; G06F 17/30097; G06F 17/30156; G06F 2221/0753; G06F 21/602; H04L 9/3213; G06F 21/10

(57) ABSTRACT

A system and method for tracking the creation and evolution of a digital file, the system and method includes determining at a collector agent, a change to the digital file, retrieving metadata about the digital file, applying at least one tokenizing algorithm to calculate a plurality of tokens, performing w-shingling operations on the contents of the digital file, calculating a hash of the digital file, assembling a fingerprint, the fingerprint being a unique identifier of the digital file and based at least in part on the plurality of tokens, the hash, and the metadata results.

### RELATED APPLICATIONS

This application claims benefit of priority to U.S. Provisional Patent Application No. 62/457,553, filed Feb. 10, 2017, which patent application is incorporated by reference in its entirety herein.

### FIELD OF THE DISCLOSED EMBODIMENTS

The disclosed embodiments relate generally to digital information security and risk management, and more particularly to managing an audit log associated with a file.

### BACKGROUND

As valuable assets move increasingly from physical to digital form and cross network boundaries, and as information is more easily shared and accessed across multiple computing devices, the risk of loss due to misappropriated information generally increases as well. Such information can be lost or otherwise compromised through targeted attacks (e.g., phishing, malware, etc.), carelessness, or intentional misconduct by those who obtain access to privileged information. Key challenges facing organizations, then, include protecting their assets against such threats and knowing how to respond in the event a breach occurs.

Various security products exist that address different aspects of the problem. For example, firewalls, antivirus, and data loss prevention (DLP) systems monitor network traffic, user behavior, and stored data for threat signals. In another example, digital rights management (DRM) systems encrypt file content and can track its consumption. However, while these systems can detect conditions as they arise, they typically do not give a view of the provenance and evolution over time of pieces of information. A DRM system, for example, can be used to determine if the content of a file contains data defined to be sensitive, but DRM can be foiled through obfuscating actions by a malicious user. As such, there is a need to look at the broader context in which information is created and evolves over time.

Having the context of the entire history of the life of a file is useful in many contexts, such as during regulatory compliance audits (e.g., audits related to the Health Insurance Portability and Accountability Act of 1996 (HIPAA), the Payment Card Industry Data Security Standard (PCI DSS), etc.), legal discovery, and monitoring the geographical transit of files over time. As an example, for given data privacy regulations of certain jurisdictions, it is relevant to know where, geographically, a piece of information was created, accessed, or processed. Ensuring compliance with local laws may involve determining the relationship of a file with respect to a geographic location.

Achieving this holistically is complicated by the large variety of storage systems available: local memory, cloud storage, network file shares, and the like. With the increased prevalence and ease-of-use of cloud-based file sharing services, this challenge is made more difficult for those tasked with controlling the usage behavior of an organization. Moreover, a malicious user can typically circumvent existing systems by copying sensitive content into uncontrolled formats and locations, thus avoiding detection.

Tracking versions of a file requires an algorithm for determining relatedness or resemblance. Typically, it is not enough to rely on filenames or timestamps. For example, Borthakur et al. (U.S. Pat. No. 7,188,118) describes a system for tracking versions using the compressed sizes of chunks of a file, in which similar compressed sizes indicate similar content. In another example, Smolsky (U.S. Pat. No. 6,947,933) describes a method for clustering similar files using fingerprints of chunks and a distance calculation. In yet another example, Aiken (U.S. Pat. No. 6,240,409) describes an alternative method using the length of substrings common to multiple files. In still another example, Antoun et al. (U.S. Pat. No. 9,516,312) describes a variation of a locality-sensitive hashing algorithm. Various other algorithms have been described for calculating the similarity between and among files. Such semantically-based algorithms generally require the content of the file in order to catalog them. As such, if a file is encrypted, the best similarity detection that can be done (without cracking the encryption) is whether two files are identical or not; no fuzzy matching is possible. Any approach based on a single algorithm therefore falls short for the purposes of showing how information was created and how it has evolved in a general-purpose domain.

Therefore, there exists a need for an improved system and method for managing an audit log associated with a file.

### SUMMARY

In at least one embodiment of the present disclosure, a method for tracking the creation and evolution of a digital file is provided, the method includes determining a change to the digital file, retrieving metadata about the digital file, applying at least one tokenizing algorithm, performing w-shingling operations on the contents of the digital file, calculating a hash of the digital file, and assembling a fingerprint.

In at least one embodiment of the present disclosure, the method further includes the step of normalizing data in the digital file to de-duplicate data, normalizing data in the digital file to de-duplicate data, and storing the fingerprint to a persistent data repository.

In at least one embodiment of the present disclosure, the metadata is selected from a group consisting of the digital file name, digital file size, digital file storage device location, digital file origination location, digital file creation date.

In at least one embodiment of the present disclosure, the plurality of tokens comprises characters, words, or lines of the digital file, and the tokenizing algorithm is further configured to calculate relative frequencies of each of the plurality of tokens.

In at least one embodiment of the present disclosure, a system for tracking the creation and evolution of a digital file is provided, the system includes a collector agent, to determine a change to the digital file, a correlation engine operably connected to the collector agent to retrieve metadata about the digital file, the correlation engine further configured to apply at least one tokenizing algorithm to calculate a plurality of tokens, perform w-shingling operations on the contents of the digital file, calculate a shingle group, and calculate a hash of the digital file and assemble a fingerprint, the fingerprint being a unique identifier of the digital file and based at least in part on the plurality of tokens, the hash, and the metadata.

In at least one embodiment of the present disclosure, the correlation engine normalizes data in the digital file to de-duplicate data, and calculates relative frequencies of each of the plurality of tokens.

In at least one embodiment of the present disclosure, the correlation engine stores the fingerprint to a persistent data repository.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic block diagram of an illustrative embodiment of a system for collecting and collating historical data associated with a file from one or more file data collector computing devices communicatively coupled to a file provenance computing device that includes a data correlation engine and a file story generation engine of a file provenance platform;

FIG. 2 is a block diagram of an illustrative embodiment of one of the computing devices of the system of FIG. 1;

FIG. 3 is a schematic block diagram of an illustrative embodiment of a collector agent that may be executed by one or more of the file data collector computing devices of the system of FIG. 1;

FIG. 4 is a schematic flow diagram of a method for performing the collation of data that may be performed by a collector agent of the data correlation computing device of the system of FIG. 1;

FIG. 5 is a schematic block diagram of an illustrative embodiment of a cloud collector agent that may be executed by one or more of the file data collector computing devices of the system of FIG. 1;

FIG. 6 is a schematic flow diagram of a method for performing the collation of data that may be performed by a cloud collector agent of the data correlation computing device of the system of FIG. 1

FIG. 7 is a schematic flow diagram of a method for performing a file fingerprinting process that may be performed by a data correlation engine of the data correlation computing device of the system of FIG. 1;

FIG. 8 is a schematic flow diagram of a data communication flow for performing a clustering process that may be performed by a data correlation engine of the data correlation computing device of the system of FIG. 1; and

FIG. 9 is an illustrative timeline of a file story that may be generated by the file story generator engine of the file story generator computing device of the system of FIG. 1.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

Herein we refer to operations as any instance of a file being touched by an application process; including reading, changing, moving/renaming, copying, and deleting. Cloud providers are defined as network-based (such as Internet-based, for example) file sharing and storage services.

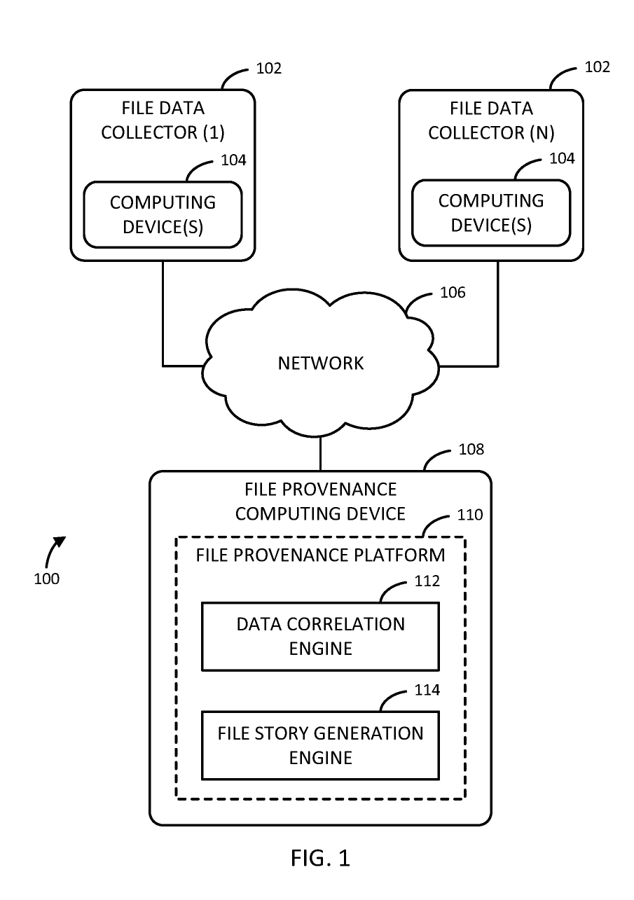

Referring now to FIG. 1, a system 100 for collecting and collating historical data associated with a file includes one or more file data collectors 102 communicatively coupled via a network 106 to a file provenance computing device 108. In use, the file provenance computing device 108 generates a historical record of the existence and evolution of a file based on data associated with the file, as may be provided from one or more of the file data collectors 102. To do so, the file provenance computing device 108 monitors the various locations (e.g., the file provider computing devices 104) at which the file could be stored and collects data associated with the file. Of course, complete monitoring of every potential storage location may not be possible. As such, the file provenance computing device 108 may additionally be configured to employ heuristic technologies for determining the provenance of a file, such as by using fingerprint data of the file and all other files in the corpus.

The file data collectors 102 are illustratively shown as a first file data collector 102 designated as file data collector (1) and a second file data collector 102 designated as file data collector (N), in which N is a positive integer that denotes any number of additional file data collectors 102. The file data collectors 102 may include any type of file manager or data storage entity. As shown in the illustrative system 100 of FIG. 1, each of the file data collectors 102 includes one or more computing devices 104. Each of the computing devices 104 may be embodied as any type of computing device capable of performing the functions described herein, including performing operations on a file (e.g., creating, uploading, moving, accessing, modifying, viewing, downloading, sharing, copying, renaming, deleting, etc.), auditing such operations performed on the file, and/or transmitting the audited file data, event data, and/or fingerprint data from the file data collectors 102 to the file provenance computing device 108.

Accordingly, such computing devices 104 may include, but are not limited to, endpoint computing devices (e.g., a desktop computer, a mobile computing device, or any other type of “smart” or otherwise Internet-connected device), one or more servers (e.g., stand-alone, rack-mounted, etc.), compute devices, storage devices (e.g., network-attached storage (NAS) devices), routers, switches, network security monitoring devices (e.g., access control devices, firewalls, intrusion prevention/detection devices, etc.), and/or combination of compute blades and data storage devices (e.g., of a storage area network (SAN)), such as may be deployed in a cloud architected network or data center.

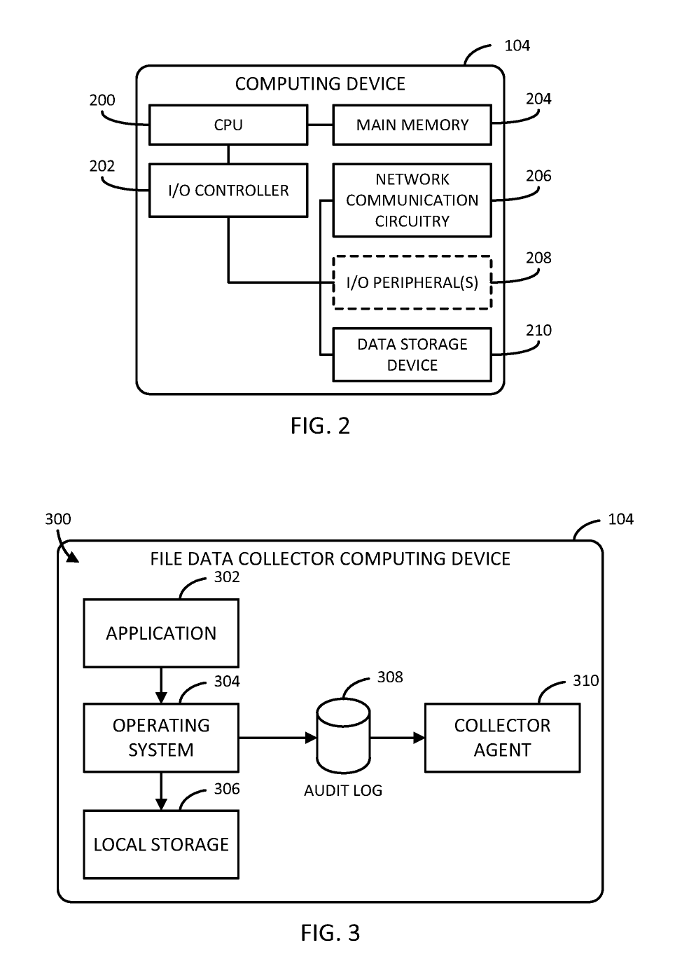

Referring now to FIG. 2, an illustrative embodiment of at least one of the computing devices 104 is shown. The illustrative computing device 104 includes a central processing unit (CPU) 200, an input/output (I/O) controller 202, a memory 204, a network communication circuitry 206, and a data storage device 210, as well as, in some embodiments, one or more I/O peripherals 208. It should be appreciated that alternative embodiments may include additional, fewer, and/or alternative components to those of the illustrative computing device 104, such as a graphics processing unit (GPU). It should be further appreciated that one or more of the illustrative components may be combined on a single system-on-a-chip (SoC) on a single integrated circuit (IC). Additionally, it should be appreciated that the type of components of the respective computing device 104 may be predicated upon the type and intended use of the respective computing device 104.

The CPU 200, or processor, may be embodied as any combination of hardware and circuitry capable of processing data. In some embodiments, the computing device 104 may include more than one CPU 200. Depending on the embodiment, the CPU 200 may include one processing core (not shown), such as in a single-core processor architecture, or multiple processing cores, such as in a multi-core processor architecture. Irrespective of the number of processing cores and CPUs 200, the CPU 200 is capable of reading and executing program instructions. In some embodiments, the CPU 200 may include cache memory (not shown) that may be integrated directly with the CPU 200 or placed on a separate chip with a separate interconnect to the CPU 200. It should be appreciated that, in some embodiments, pipeline logic may be used to perform software and/or hardware operations (e.g., network traffic processing operations), rather than commands issued to/from the CPU 200.

The I/O controller 202, or I/O interface, may be embodied as any type of computer hardware or combination of circuitry capable of interfacing between input/output devices and the computing device 104. Illustratively, the I/O controller 202 is configured to receive input/output requests from the CPU 200, and send control signals to the respective input/output devices, thereby managing the flow of data to/from the computing device 104.

The memory 204 may be embodied as any type of computer hardware or combination of circuitry capable of holding data and instructions for processing. Such memory 204 may be referred to as main or primary memory. It should be appreciated that, in some embodiments, one or more components of the computing device 104 may have direct access to memory, such that certain data may be stored via direct memory access (DMA) independently of the CPU 200.

The network communication circuitry 206 may be embodied as any type of computer hardware or combination of circuitry capable of managing network interfacing communications (e.g., messages, datagrams, packets, etc.) via wireless and/or wired communication modes. Accordingly, in some embodiments, the network communication circuitry 206 may include a network interface controller (NIC) capable of being configured to connect the computing device 104 to a computer network (e.g., the network 106), as well as other devices, depending on the embodiment.

The one or more I/O peripherals 208 may be embodied as any auxiliary device configured to connect to and communicate with the computing device 104. For example, the I/O peripherals 208 may include, but are not limited to, a mouse, a keyboard, a monitor, a touchscreen, a printer, a scanner, a microphone, a speaker, etc. Accordingly, it should be appreciated that some I/O devices are capable of one function (i.e., input or output), or both functions (i.e., input and output).

In some embodiments, the I/O peripherals 208 may be connected to the computing device 104 via a cable (e.g., a ribbon cable, a wire, a universal serial bus (USB) cable, a high-definition multimedia interface (HDMI) cable, etc.) of the computing device 104. In such embodiments, the cable may be connected to a corresponding port (not shown) of the computing device 104 for which the communications made there between can be managed by the I/O controller 202. In alternative embodiments, the I/O peripherals 208 may be connected to the computing device 104 via a wireless mode of communication (e.g., Bluetooth®, Wi-Fi®, etc.) which can be managed by the network communication circuitry 206.

The data storage device 210 may be embodied as any type of computer hardware capable of the non-volatile storage of data (e.g., semiconductor storage media, magnetic storage media, optical storage media, etc.). Such data storage devices 210 are commonly referred to as auxiliary or secondary storage, and are typically used to store a large amount of data relative to the memory 204 described above.

Referring back to FIG. 1, the network 106 may be implemented as any type of wired and/or wireless network, including a local area network (LAN), a wide area network (WAN), a global network (the Internet), etc. Accordingly, the network 106 may include one or more communicatively coupled network computing devices (not shown) for facilitating the flow and/or processing of network communication traffic via a series of wired and/or wireless interconnects. Such network computing devices may include, but are not limited, to one or more access points, routers, switches, servers, compute devices, storage devices, etc. It should be appreciated that, due to the sensitive nature of the patient data being transmitted, the communication channels used to transmit the patient data may be secured prior to transmission of the patient data.

The file provenance computing device 108 may be embodied as any type of compute and/or storage device capable of performing the functions described herein. For example, the file provenance computing device 108 may be embodied as, but is not limited to, one or more servers (e.g., stand-alone, rack-mounted, etc.), compute devices, storage devices, routers, switches, and/or combination of compute blades and data storage devices (e.g., of a SAN) in a cloud architected network or data center. It should be appreciated that the file provenance computing device 108 may contain like components to that of the illustrative computing device 104 of FIG. 2. Accordingly, such like components are not described herein to preserve clarity of the description.

While the file provenance computing device 108 is illustrated as a single computing device, it should be appreciated that, in some embodiments, the file provenance computing device 108 may consist of more than one computing device (e.g., in a distributed computing architecture), each of which may be usable to perform at least a portion of the functions described herein. As such, each computing device of the file provenance computing device 108 may include different components (i.e., hardware/software resources), the types of which may be predicated upon the type and intended use of each computing device. For example, one computing device of the file provenance computing device 108 may be configured as a database server with less compute capacity relative to the compute capacity of another of the computing devices of the file provenance computing device 108. Similarly, one computing device of the file provenance computing device 108 may be configured as an application server with more compute capacity relative to the compute capacity of another computing device of the file provenance computing device 108.

In some embodiments, the file provenance computing device 108 may include a file provenance platform 110. The file provenance platform 110 may be embodied as any combination of hardware, firmware, software, or circuitry usable to perform the functions described herein. In some embodiments, the file provenance platform 110 may be embodied as any type of network-based software application (e.g., cloud application, network application, software-as-a-service (SaaS) application, etc.) configured to communicate with the file data collectors 102, or more particularly the computing devices 104 (e.g., in a client-server architecture). Accordingly, in such embodiments, one or more of the computing devices 104 may execute a client application, which may be embodied as a thin client (e.g., a web browser, an email client, etc.) or thick client, that is configured to communicate with the file provenance platform 110 over the network 106 to provide one or more of the services described herein to a user. It should be appreciated that, in some embodiments, the user as referred to herein may refer to a person (i.e., a human user) or the computing device 104 itself.

The illustrative file provenance platform 110 includes a data correlation engine 112 and a file story generation engine 114. In some embodiments, the data correlation engine 112 and/or the file story generation engine 114 may include one or more computer-readable medium (e.g., the memory 204, the data storage device 210, and/or any other media storage device) having instructions stored thereon and one or more processors (e.g., the CPU 200) coupled with the one or more computer-readable medium and configured to execute instructions to perform the functions described herein.

The data correlation engine 112, which may be embodied as any type of firmware, hardware, software, circuitry, or combination thereof, is configured to collect audit operations (e.g., access of a file, creation or modification of a file, sharing a file with collaborators, moving or deleting or copying a file, renaming a file, etc.), metadata (e.g., the file name, size, storage device location, geographic location, creation date, etc.), and content (e.g., fingerprints, content features, encryption status, etc.) from the file data collectors 102, as well as normalize and properly relate the various data streams. For instance, if the same file is shared among multiple computing devices 104, the data normalization performed by the data correlation engine 112 can de-duplicate information arriving from these multiple collectors.

The file story generation engine 114, which may be embodied as any type of firmware, hardware, software, circuitry, or combination thereof, is configured to uses the processed data to display the history of a file (e.g., to a user requesting the file history).

Referring now to FIG. 3, an illustrative environment 300 of a file data collector computing device 104 includes an application 302, an operating system 304, a local storage 306 (e.g., the main memory 204 of FIG. 2), an audit log 308, and a collector agent 310. The operating system 304 of the computing device 102 provides a common way for applications to access the hardware of the computing device 102, including the local storage 306 (e.g., the main memory 204 of FIG. 2, a memory cache (not shown) associated with the CPU 200 of FIG. 2, and/or other local storage options). Accordingly, various operations can be monitored at the operating system 304 level, such as file operations of the computing device 102. The implementation is generally specific to each operating system 304 of the respective computing device 102. For example, in some embodiments, specific extensions may be used on each platform to capture the stream of file operations occurring on a user device. In the illustrative environment 300, the collector agent 310 is configured to monitor and capture at least a portion of such file operations.

It should be appreciated that the application 302 may be an end-user application, a system service (e.g., a virus scan), or another type of application capable of being executed on the computing device 102. As the application 302 performs file operations, the file operations are captured by the operating system 304 in the audit log 308 (e.g., a database). The collector agent 310 is configured to observe the audit log 308.

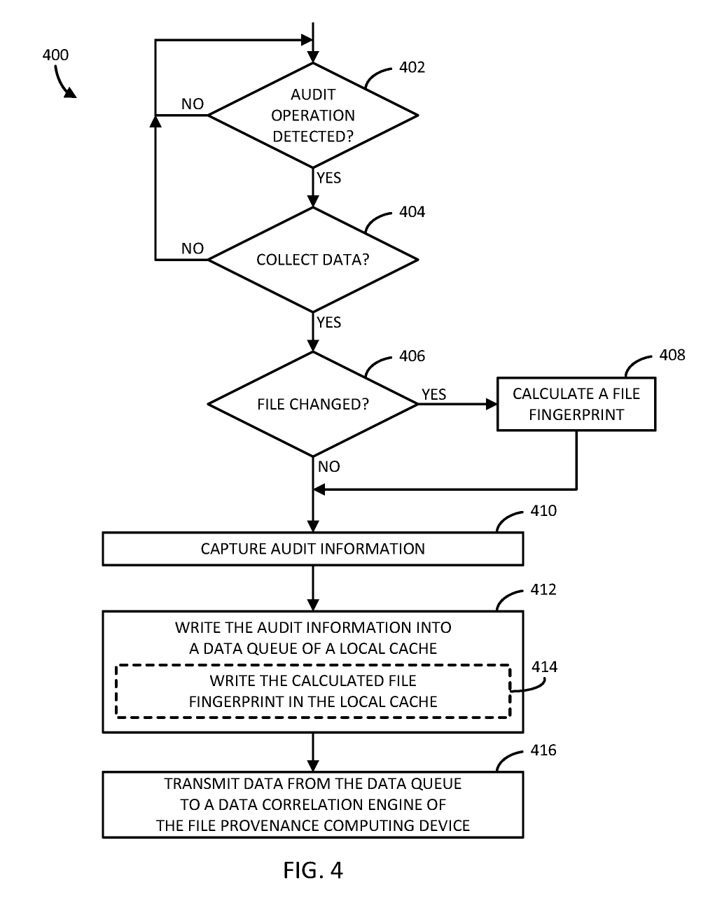

Referring now to FIG. 4, an illustrative method 400 for collecting data file information is shown that may be performed by the collector agent 310 of the computing device 104. The method 400 begins in block 402, in which the collector agent 310 determines whether an audit operation has been detected as a result of the aforementioned monitoring of the audit log 308. If so, the method 400 advances to block 404, in which the collector agent 310 determines whether to collect the data. Each collector agent 310 is controlled by a policy which instructs it to monitor or ignore certain files, due to potentially negative performance implications otherwise. Accordingly, if a file audit operation matches this policy, the file audit operation will be processed by the collector agent 310, and the method 404 advances to block 406.

In block 406, the collector agent 310 determines whether the file has changed (i.e., whether content of the file has been modified). If the collector agent 310 determines that the file's content has been modified (e.g., in the case of a creation or change operation), then the method 400 will branch to block 408; otherwise, the method 400 will branch to block 410. In block 408, the collector agent 310 calculates a file fingerprint, which will be described in further detail below, before the method advances to block 410. In block 410, the collector agent 310 captures audit information associated with the audit operation detected in block 402.

In block 412, the collector agent 310 writes the captured audit information into a data queue in a local memory cache (e.g., the local storage 306). Additionally, in block 414, in such embodiments in which the file fingerprint was calculated in block 408, the collector agent 310 additionally stores the file fingerprint in the local memory cache. In some embodiments, the data may be stored in a first-in-first-out (FIFO) queue. In such embodiments, a header may serve as a pointer to the current location in the queue. In block 416, the collector agent 310 transmits the data from the data queue to the data correlation engine 112 of the file provenance computing device 108.

Upon successful receipt of the data, the data correlation engine 112 may be configured to return an indication as to whether the transmission succeeded or failed. In the case of a successful transmission, the pointer can be advanced by the collector agent 310 to the next data record. In the case of a failed transmission, a queue pointer associated with the data may not be advanced by the collector agent 310, in which case the collector agent 310 can attempt to resend the same data at a later point in time. In some embodiments, the local memory cache may be implemented as a memory-mapped file to avoid a performance impact to the system.

Due to the potentially sensitive nature of the data, the data may be encrypted when stored in the local memory cache and/or during transmission. In a data collection network with multiple collector agents 310 installed, the amount of network bandwidth utilized for transmitting data from the collector agents 310 to the data correlation engine 112 has the potential to be bandwidth intensive. Accordingly, the transmission of data can be adjusted to influence network bandwidth usage between the collector agent 310 and the data correlation engine 112. In one embodiment, this could be implemented as a toggle for either sending data as it is collected (near-real-time), or batching the data for transmission during off-peak hours.

In some embodiments, collecting data file information by the collector agent 310 of the computing device 104 may not be feasible. For example, cloud providers can present a different challenge, as each cloud provider can use a different architectural/platform implementation. To capture all file operations for these systems which exist outside the control of a user's organization, it may be necessary to restrict access to those cloud providers for which an authorized linkage is possible and for which that linkage can be used to retrieve the necessary audit and fingerprint data.

For example, a cloud provider may record audit operations (e.g., creation, upload, modification, view, download, share, copy, rename, etc.) for those files stored with that provider and only make such data available for retrieval through an authorized interface. Similarly, the fingerprinting process generally requires access to the content of the file, and as such it is beneficial to have an authorized interface for retrieving a file in order to fingerprint it. If a cloud provider does not provide such interfaces, then it is necessary to intercept and examine network traffic between the client and the cloud provider. From this network traffic, an inference can be made regarding the operations being performed or the data being uploaded in order to fingerprint it while in transit.

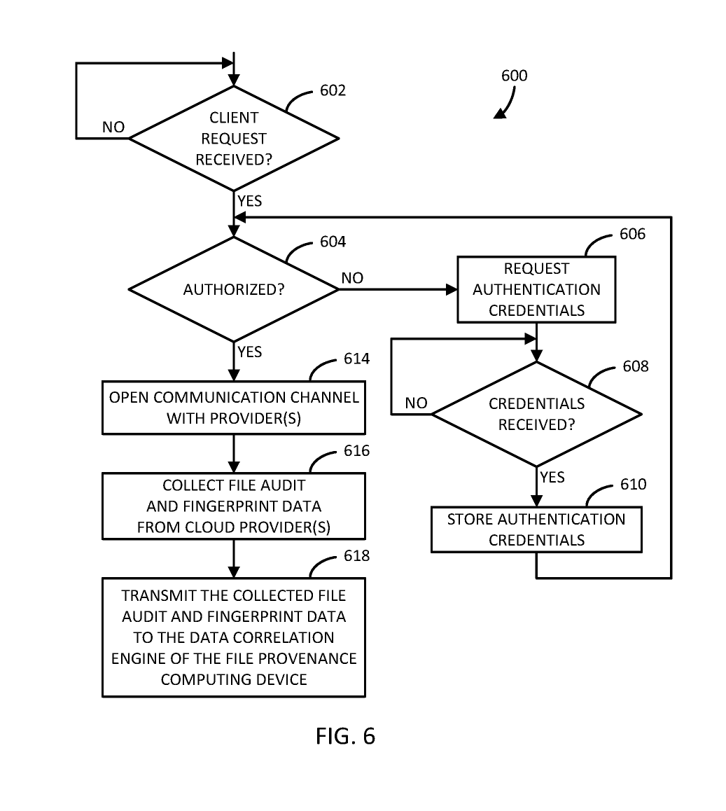

Regardless of the technique used, each interface is typically unique to a cloud provider, and it is likely that as new cloud providers come into existence, there will be a delay until the particulars of the new system can be understood and integration support developed. As a result, an organization wishing to prevent file data from being stored on a cloud provider for which audit and fingerprint data cannot be retrieved, or which is known for insufficiently strict security policies, must have the ability to control access to such a provider. This control involves redirecting network traffic from a client computing device to one or more file data collector computing devices 104 of a cloud provider, inspecting the network traffic for adherence to a policy, and then acting to control it (see, e.g., the method 600 of FIG. 6). In some embodiments, the redirect can be performed locally (on a client machine), while in other embodiments the redirect can be performed at the network level. In some embodiments, the inspection can be done at the transport (e.g., packet filtering) or at the application (e.g., content filtering) level. It should be appreciated that, in order to inspect the data stream, knowledge of each cloud provider's implementation may be required in advance of the interception and inspection.

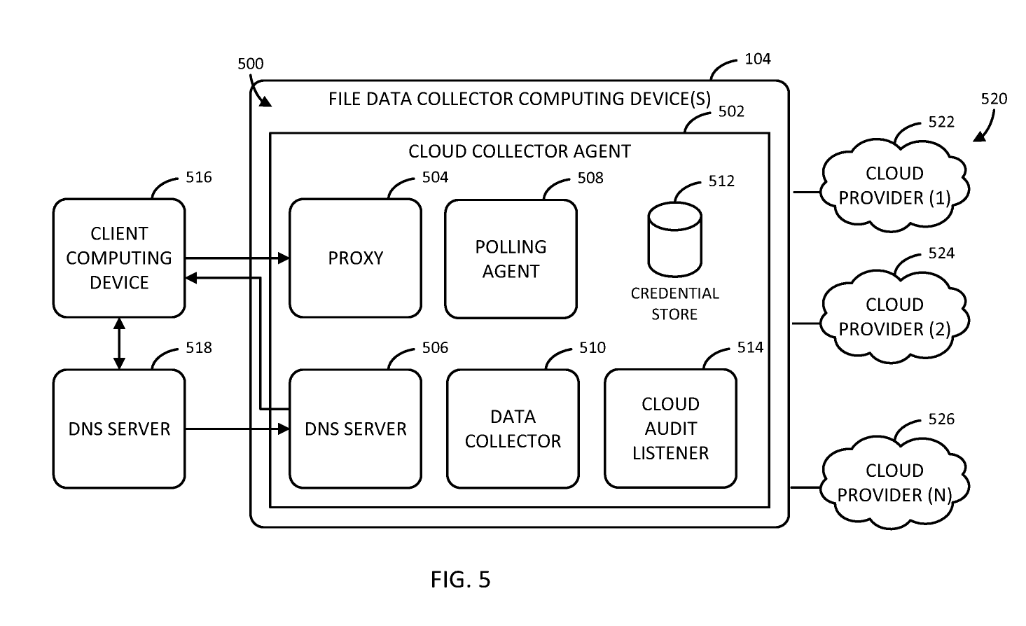

Referring now to FIG. 5, an illustrative environment 500 of a file data collector computing device 104 shows an embodiment of a cloud collector agent 502 which is configured to capture file audit and fingerprint data in a cloud environment (i.e., from one or more cloud providers 520). The illustrative cloud collector agent 502 includes a proxy 504, a domain name server (DNS) 506, a polling agent 508, a data collector 510, a cloud audit listener 514, and a credential store 512. The collector agent 502 is communicatively coupled to a client computing device 516, a client's DNS server 518, and one or more cloud providers 520.

As illustratively shown, the cloud collector agent 502 may be installed as a standalone system on a separate network from both the client computing device 516 and the client's DNS server 518. However, because the cloud collector agent 502 operates as a proxy, maintaining the cloud collector agent 502 in proximity to the client (e.g., on the local network) can minimize the performance impact attributable to network latency.

In use, a client (i.e., an end user on the network) operating the client computing device 516 performs an action, via a browser or a client application of the client computing device 516. In response to that action, the browser or client application sends a query to a domain name server (DNS) 518 to resolve a network IP address (e.g., IPv4, IPv6, etc.) based on a domain name associated with the action (e.g., corresponding to a domain name portion of uniform resource identifier (URI) string in which the domain name corresponds to a website associated with the aforementioned action). It should be appreciated that the requested name is sent in plain text regardless of whether the message content is secured. Accordingly, the content of the query need not be encrypted.

The DNS server 518 can be preconfigured to delegate the resolution of names of relevant cloud providers 520 to the cloud collector agent 502, and treat all other queries normally. This configuration, which would be performed by the owner of the network, entails adding an Alias (A) or Common Name (CNAME) record for each cloud provider 520 to the organization's DNS. Such records cause the cloud provider's name to resolve to the IP address of the cloud agent collector 502. In the case where a client computing device 516 attempts to connect to an IP address that is not of interest as a cloud provider 520, the DNS server 518 returns the address as usual and the client makes the connection. In the case where the client connects to a cloud provider 520, the DNS server 518 delegates the resolution to the DNS server of the cloud collector agent 506, which then resolves the IP address to the web proxy 504 of the cloud collector agent 502, and the client then connects to the proxy 504.

Referring now to FIG. 6, an illustrative method 600 is provided for collecting data file information that may be performed by the cloud collector agent 502 of the computing device 104. The method 600 begins in block 602, in which the cloud collector agent 502 determines whether a request has been received from the client computing device 516. If so, the method advances to block 604, in which the cloud collector agent 502, or more particularly the proxy 504 of the cloud collector agent 502, determines whether the user associated with the request received from the client computing device 516 is authorized to access the cloud provider 520 associated with the request.

To do so, the proxy 504 inspects the request to evaluate whether the user has been authorized to access the requested provide by authenticating the user's previously stored credentials (e.g., stored in the credential store 512) and the organizational policy. The organizational policy is usable to determine whether to allow or block access to certain cloud providers 520. In other words, the proxy 504 is configured to enforce the organization policy to determine whether the client has access, and then validate the authentication credentials associated with the client. It should be appreciated that obtaining authorization can take a different course depending on the specific implementation of each cloud provider 520. For example, in one embodiment, the cloud provider 520 utilizes an OAUTH2.0 process to authenticate the client's credentials.

It should be appreciated that without organizational policy allowance and client authorization, the connection of the client computing device 516 to certain cloud providers 520 should not be allowed. Under such conditions, the cloud collector agent 502 may provide an indication to the user (e.g., transmit a notification to the client computing device 516) indicating that the authentication process failed. If the authentication process failed due to the authentication credentials not being valid, or not yet having been received by the proxy 504, the method 600 branches to block 606. In block 606, the proxy 504 requests the authentication credentials from the user. In block 608, the proxy 504 determines whether the authentication credentials have been received. If so, the method 600 advances to block 610, in which the authentication credentials are stored in the credential store 512 before the method 600 returns to block 604 to determine whether the user is authorized based on the authentication credentials received in block 608 and the applicable organizational policy.

If the user is authorized in block 604, the method 600 advances to block 614. In block 614, a communication channel is opened between the cloud collector agent 502 and one or more cloud providers 520, and the request is allowed to proceed to the respective cloud provider. Subsequent requests can be evaluated in a similar manner. It should be appreciated that by granting authorization, the user has consented to the cloud collector agent 502 retrieving file audit and fingerprint data from the cloud provider(s) 520 on the user's behalf.

In block 616, the data collector 510 is configured to collect audit and fingerprint data from each cloud provider 520 for which the user's access thereto has been authenticated. To do so, in some embodiments, the cloud providers 520 notify the data collector 510 whenever a file operation occurs via the cloud audit listener 514. In such embodiments, the cloud audit listener 514 is configured to receive an operation notification, transform the operation notification to the desired format, recalculate the file fingerprint (if the file was changed), and forward the data to the data collector 510. Alternatively, in other embodiments in which the cloud provider(s) 520 does not support a call-back process such as this, the polling agent 508, using the user's credentials, may be configured to periodically retrieve this information from the cloud provider(s) 520.

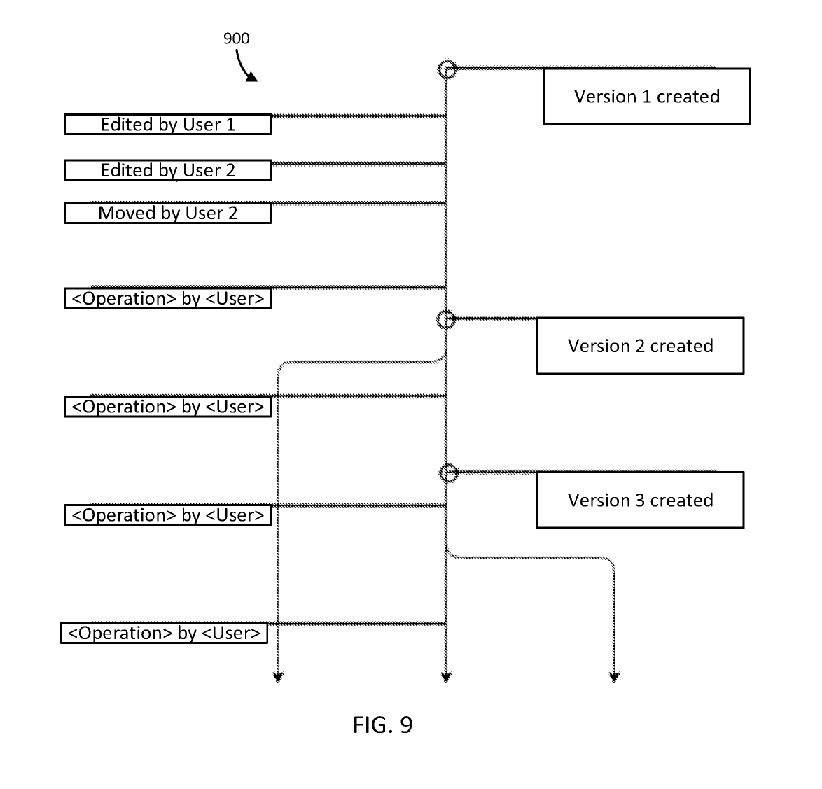

It should be appreciated that an alternative approach may be undertaken for network security and detection devices, including email servers, antivirus systems, and data loss prevention (DLP) systems. Many of these systems expose interfaces that can be used to obtain a notification when an event of interest occurs. An event of interest from these systems may include a file being sent as an attachment, a file being quarantined, or a file matching a DLP audit policy. Such events of interest may be collected by the data collector 510 as well. In block 618, the data collector transmits the collected file audit and fingerprint data to the data correlation engine 112 of the file provenance computing device 108. As a result, the data correlation engine 112 can consume the data (e.g., file audit data, file fingerprint data, events of interest data, etc.) and include them in the timeline of the file as described below (see, e.g., FIG. 9).

With the file audit and fingerprint data being collected and sent to the data correlation engine 112, the data correlation engine 112 may then normalize and correlate the various input streams. The normalization and correlation may include removing duplicate information, building references between related data entities, and building statistical summaries on the raw data for faster retrieval. It should be appreciated that, in some cases, gaps or omissions in the audit data may be present. For example, for a file emailed into an organization, it may not be possible to detect earlier versions of the attachment on the sender's computing device. Accordingly, in such cases, the fingerprint data may be used to establish a probabilistic sequence of events.

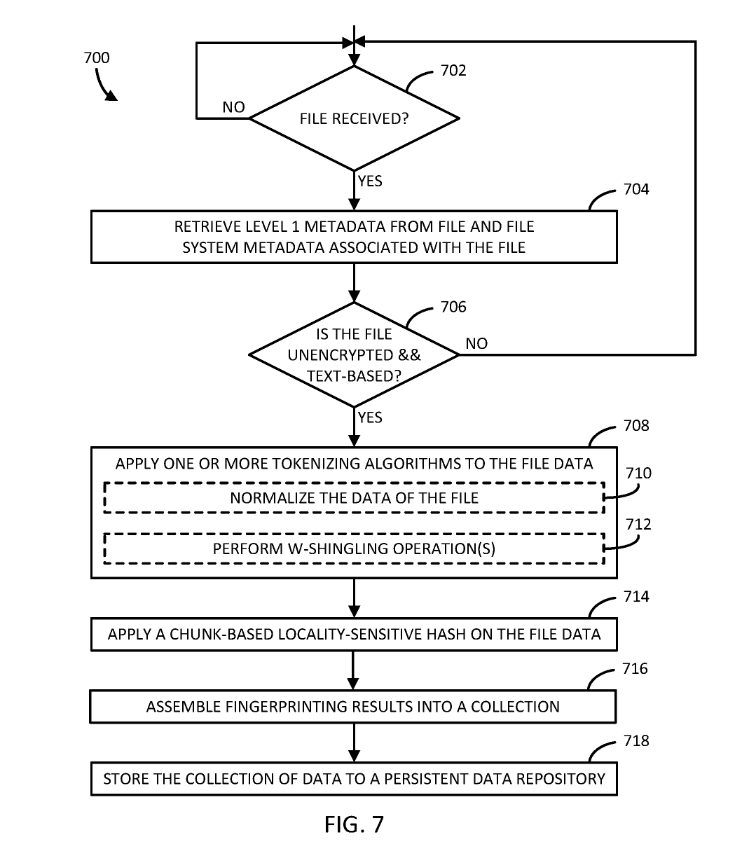

Referring now to FIG. 7, an illustrative method 700 for performing a file fingerprinting process is shown that may be performed by the data correlation engine 112 of the file provenance computing device 108. The method 700 begins in block 702, in which the data correlation engine 112 determines whether a file has been received. If so, the method 700 advances to block 704, in which the data correlation engine 112 retrieves as much metadata (e.g., the file name, size, storage device location, geographic location, creation date, etc.) from the file as can be retrieved. Regardless of the file type or whether the file is encrypted, the metadata may include the MD5 sum and/or the file name.

If the file is unencrypted, or encrypted with certain types of encryption, the data correlation engine 112 may be configured to determine a type of the file by examining the format of the underlying data. For example, some file formats have an invariant identifier in a fixed position near the beginning of the file data. In some embodiments, the data correlation engine 112 may be configured to compare the identifier against a table of known values to determine the file type. Generally, for encrypted data, such a technique will not work.

As such, several heuristic approaches may be employed by the data correlation engine 112 to determine whether a file is encrypted, such as by looking at the randomness of the data (i.e., the entropy) coupled with a chi-squared test to distinguish encrypted data from compressed data. Additionally, the file extension (if available) may be considered. If the file extension is available, access control list data, such as the owner, creator, list of users who can edit, and the list of users who can access the file, may be provided to the fingerprinting process. Collectively, such data points are referred to herein as the Level 1 metadata.

In block 706, the data correlation engine 112 determines whether the file is unencrypted and text-based. If so, additional semantic fingerprints can be gathered and the method 700 advances to block 708. In block 708, data correlation engine 112 applies one or more tokenizing algorithms. Accordingly, a list of the tokens contained in a document, their relative frequencies, and several reduced versions of this data (e.g. a sampling of 20 tokens, a sampling of 100 tokens, etc.) could allow for calculating several similarity calculations, such as the Jaccard index. For example, in block 710, in some embodiments, the data correlation engine 112 may be configured to normalize the data (e.g., to de-duplicate information arriving from multiple collector agents). Additionally or alternatively, in block 712, in some embodiments, the data correlation engine 112 may be configured to perform w-shingling operations on the contents of the file (e.g., to gauge similarities between the present content of a file and the content of that file analyzed previously).

In block 714, the data correlation engine 112 is configured to apply a chunk-based locality-sensitive hash on the file data. It should be appreciated that the data correlation engine 112 may be configured to apply additional and/or alternative computational algorithms for detecting changes to the contents of a file (i.e., other content-specific techniques), in other embodiments. For example, specialized algorithms may be used for fingerprinting image or audio data. In block 716, the data correlation engine 112 is configured to assemble the fingerprinting results into a collection. In block 718, the data correlation engine 112 is configured to store the collection of to a persistent data repository (i.e., for future use). It should be appreciated that the fingerprinting process may be conducted each time the content of a file or the metadata associated with a file changes.

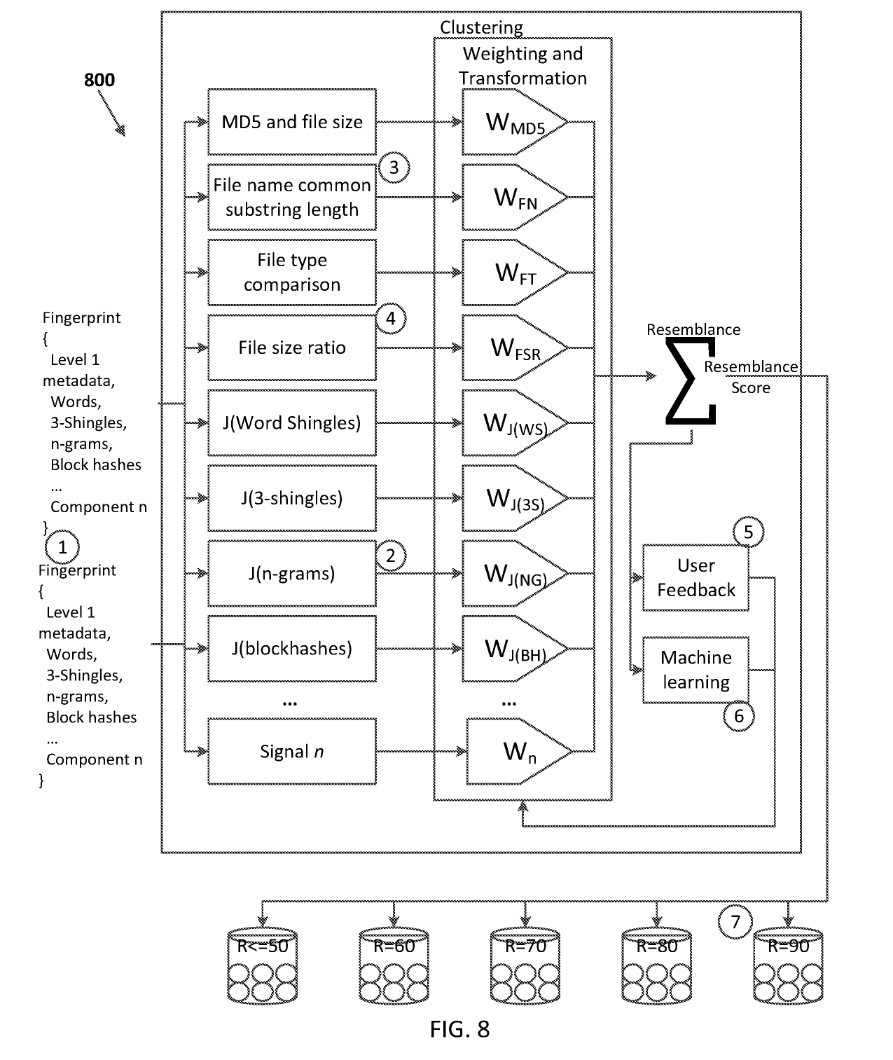

Referring now to FIG. 8, an illustrative data transmission flow 800 is provided for a clustering technique usable to determine the resemblance between two files that may be performed by the data correlation engine 112. It should be appreciated that this approach is extensible to accommodate an arbitrary number of fingerprint components, apply weightings and interactions to transform the components to input signals, and then sum the input signals to arrive at a resemblance score, ranging from 0 to 100. The resulting output is a list of clusters of files which resemble each other, given some threshold for clustering.

To do so, in data flow (1), two fingerprint collections are input and unpacked by the data correlation engine 112. It should be appreciated that, depending on the component, additional transformations may be applied. In one example, in data flow (2), the data correlation engine 112 calculates Jaccard index as a measure of distance between two groups of shingles (i.e., contiguous subsequences of tokens in a document, commonly referred to as n-grams). In another example, in data flow (2), the data correlation engine 112 calculates a resemblance between the filenames by summing the length of all non-overlapping shared sequences and dividing that by the sum of the length of both file names. In still another example, in data flow (4), the data correlation engine 112 calculates a resemblance of the file sizes as a simple ratio.

It should be appreciated that additional and/or alternative weighting and transformation operations may be performed. For example, in some embodiments, the data correlation engine 112 may be configured to calculate the ratio of word counts between files. In other embodiments, the data correlation engine 112 may be configured to calculate the term frequency-inverse document frequency (tf-idf) between a file and a cluster of files (i.e., the corpus) to determine membership. In still other embodiments, the data correlation engine 112 may be configured to compute the Hamming distance of the filenames.

Additionally, file types may be used to increase or decrease the probability a file has membership in a cluster. For example, a text document and a computer-aided design (CAD) drawing are unlikely to have similar content, but a text file and a PDF file may. In the same way, other pairs of fingerprint components can be converted to input signals. As such, the data correlation engine 112 may then calculate a weighted average. The weights for each component, ranging from 0 to 100, can depend on the input signals being considered.

For example, in one embodiment, the signal indicating equivalence of the MD5 and file size (to control for MD5 collisions) could be given an exclusive binary rating: the two files are either equivalent or they are not. In such embodiments, if the files are equivalent, all other signals can be ignored, as the resemblance is set to 100 (i.e., equivalent). In some embodiments, the MD5 signal may be the only binary rating that is applicable. Accordingly, in such embodiments, the other signals have a weighting of less than 100, and those weights can be adjusted dynamically. In an illustrative example, for encrypted files, where file type, w-shingling, and other content-based signals are not available, the weighting on file name common substrings and file size may be increased. Additionally or alternatively, when comparing text-based documents, the weighting on the content-based signals may be increased. It should be appreciated that specific formulas or weights described herein are not limiting.

In some embodiments, the transform applied to each input signal may be tunable, either through machine learning or user feedback, for example. However, it should be appreciated that the input signals should be optimized for a given set of fingerprint components. For example, in data flow (5), user feedback may be used to tune one or more input signals. Such user feedback may include user click behavior, such as which resembling files are clicked and which are ignored, or explicit tuning inputs such as the MD5 equivalence comparison described above. Other user feedback may include explicit or implicit filtering, where the area of interest is limited to specific file formats, files from specific locations, or files having a particular type of audit operation occurring within a specific time period.

In some embodiments, in data flow (6), machine learning input may be used to tune one or more input signals. Such machine learning input may include running an independent algorithm that is known to produce reasonable results, and using a goal seeking pattern to mechanically determine optimal signal transformations. For example, by computing a similarity score using an algorithm known for producing reasonable results (e.g. MinHash, SimHash, etc.) which was not used as an input signal, comparing that to the resemblance score produced by the weighted average, and then performing a Monte Carlo simulation for various groups of file inputs, the weights may be optimized for a given corpus.

In this way, the resemblance score can be calculated between every pair of input fingerprints in the corpus. The resulting resemblance score will be either 100 (in the case of a binary rating, with the MD5 signal) or a number between 0 and 99. Because the resemblance should only be calculated when a file and its associated fingerprint changes, in data flow (7) the resulting resemblance scores can be stored for subsequent retrieval (e.g., for future comparison).

The data correlation engine 112 is configured to compare each fingerprint with one or more other fingerprints. Accordingly, in data flow (8), the data correlation engine 112 is configured to assemble the fingerprints into clusters (8), which may be based on a given cohesiveness factor in terms of maximum distance, for example. The clustering threshold may be tunable. For example, to improve the performance of retrieval operations, the clusters may be partitioned into buckets based on their cohesiveness. In other words, clusters having resemblance of 90 and above, of 80 to 90, of 70 to 80, and so on, will be grouped into respective buckets. Within each cluster bucket (e.g., the bucket containing clusters with a resemblance between 80 and 90), we store clusters whose members have a resemblance score in that range. It should be appreciated that the pair-wise score for every set of 2 files in the cluster may not be stored.

At the time of retrieval, a user can request files having some resemblance score (say, 85 or higher) to a given file. Under such conditions, the data correlation engine 112 is configured to retrieve those files identified in every cluster in the 80 to 90 cluster bucket, and every cluster in the 90 to 100 cluster bucket, which contains the given file, and compute the pair-wise resemblance score between the given file and the other files in the matching clusters. Accordingly, the need for creating and maintaining a large number of pair-wise scores may be avoided, and the number of resemblance scores that need to be calculated at run time may be minimized. It should be appreciated that this additional bucketing operation may not be necessary for smaller sets of files.

The history of a file is described by plotting the normalized and correlated data in a graphical representation. In one embodiment, this could resemble a timeline 900, as shown in FIG. 9, which illustrates all operations in sequence at the appropriate location along the timeline 900. In summary, the fingerprint data can be used to determine the resemblance between versions of a file. The disclosed algorithm may then use the fingerprint data to identify other files in which the content bears a high resemblance to the file being examined. For example, if a file is copied to a cloud provider and then modified, the resemblance between the original file and the original copy will be 100. The modified copy will likely have a slightly lower resemblance, at a later point in time. Using this data, the file story generation engine 114 of FIG. 1 may then construct a historical view of a file (e.g., the timeline 900 of FIG. 9). Where this resemblance score is sufficiently high, the provenance of a version of a file can be inferred. In practice, a score of 80 and higher is more likely to indicate a meaningful resemblance.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1) A method for tracking the creation and evolution of a digital file, the method comprising:
determining at a collector agent, a change to the digital file;
retrieving at a correlation engine, metadata about the digital file;
applying at the correlation engine, at least one tokenizing algorithm, the at least one tokenizing algorithm configured to calculate a plurality of tokens;
performing at the correlation engine, w-shingling operations on the contents of the digital file, to calculate a shingle group;
calculating at the correlation engine, a hash of the digital file; and
assembling at the correlation engine, a fingerprint, the fingerprint being a unique identifier of the digital file and based at least in part on the plurality of tokens, the hash, and the metadata.

2) The method of claim 1, wherein the metadata is selected from a group consisting of the digital file name, digital file size, digital file storage device location, digital file origination location, digital file creation date.

3) The method of claim 1, wherein the plurality of tokens comprises characters, words, or lines of the digital file.

4) The method of claim 1, further comprising the step of normalizing data in the digital file to de-duplicate data.

5) The method of claim 1, wherein the tokenizing algorithm is further configured to calculate relative frequencies of each of the plurality of tokens.

6) The method of claim 1, wherein the hash comprises a locality-sensitive hash.

7) The method of claim 1, wherein the hash comprises an MD5 sum.

8) The method of claim 1, further comprising the step of storing the fingerprint to a persistent data repository.

9) A system for tracking the creation and evolution of a digital file, the system comprising:
a collector agent, configured to determine a change to the digital file;
a correlation engine operably connected to the collector agent and configured to retrieve metadata about the digital file;
the correlation engine further configured to apply at least one tokenizing algorithm to calculate a plurality of tokens;
the correlation engine further configured to perform w-shingling operations on the contents of the digital file and calculate a shingle group; and
the correlation engine further configured to calculate a hash of the digital file and assemble a fingerprint, the fingerprint being a unique identifier of the digital file and based at least in part on the plurality of tokens, the hash, and the metadata.

10) The system of claim 9, wherein the metadata is selected from a group consisting of the digital file name, digital file size, digital file storage device location, digital file origination location, digital file creation date.

11) The system of claim 9, wherein the plurality of tokens comprises characters, words, or lines of the digital file.

12) The system of claim 9, wherein the correlation engine is further configured to normalize data in the digital file to de-duplicate data.

13) The system of claim 9, wherein the correlation engine is further configured to calculate relative frequencies of each of the plurality of tokens.

14) The system of claim 9, wherein the hash comprises a locality-sensitive hash.

15) The system of claim 9, wherein the hash comprises an MD5 sum.

16) The system of claim 9, wherein the correlation engine is further configured to store the fingerprint to a persistent data repository.
